(19) United States
(12) Patent Application Publication
(10) Pub. No.: US 2002/0013836 A1
(43) Pub. Date: Jan. 31, 2002

(54) Interactive online learning with student-to-tutor matching

(75) Inventors: Philip Friedman, Livingston, NJ (US); Victor Friedman, Woodbury, NY (US); James B. Nevin, New York, NY (US)

Correspondence Address: DARBY & DARBY P.C., 805 Third Avenue, New York, NY, 10022, US

(73) Assignee: Homework911.com Inc.

(21) Appl. No.: 09/908,208

(22) Filed: Jul. 18, 2001

Related U.S. Application Data
(60) Provisional application No. 60/218,909, filed on Jul. 18, 2000.

(51) Int. Cl. G09G 5/00; G06F 15/173; G06F 17/60

(52) U.S. Cl. 709/223; 345/751; 705/8

(57) ABSTRACT

The online tutoring method and system selects a best available tutor and establishes an interactive learning environment for the student. The automated selection process uses a weighting system to incorporate numerous factors from and about the student and tutors. Upon receipt of a request for tutoring from a student, the matching processes is performed and a tutor is selected. Information about the participating tutors, such as proficiency in the subject matter and qualifications with respect to particular age groups, are quantified and associated with competency criteria. Information about the student, such as the type of assistance required and the student's education level are quantified and associated with request criteria that corresponds to the competency criteria. The weighting system combines the quantified information associated with the criteria to select best tutor. The weighting system may further include objective relative weights, input from the student's parent, and/or tutor certifications. The availability of the tutors are also taken into account in selecting a tutor. In one embodiment Internet technology and automatic call distributor technology may be combined to facilitate the automated selection process and for providing the framework for the tutoring sessions.

### SUMMARY OF INVENTION

The present invention automatically matches a student who requests for assistance with a suitable tutor/teacher currently available for a tutoring session. A weighting system is used to identify a suitable tutor for the student. Once a match is determined, a personal tutoring session is established between the student and the tutor. A routing server may be used to automatically facilitate communication for the tutoring session. The tutoring session may take place in real time using a computer network as a basis for the communications and a variety of interactive integrated multimedia tools.

The weighting system operates on a selection criteria relating to tutoring and education in general. The criteria incorporates the scope of students' needs and preferences as well as the scope of the tutors' expertise and skills. Preferably, the weighting system compensates for the subjectiveness of the students' description of the help requested, using objective weights developed by education experts or from experience. Supplementary weighting may also be supplied by a parent or guardian for the student or a certification authority for the tutor. These weights are used in combination to form a set of highly adaptive, multi-tiered rules that implement the matching goals of the one-on-one tutoring service.

The automated process selects a qualified tutor to assist a student who submits a request. The tutors are evaluated to determine proficiency measurements for each tutor. A predetermined set of criteria is ranked according to the request. The proficiency measurements and ranking are combined to compute a qualifier for each tutor. A tutor is selected according to a predetermined rule applied to the qualifiers. For example, the rule may be selecting the highest value qualifier, thereby indicating the most suitable tutor.

### BRIEF DESCRIPTION OF THE DRAWINGS

The foregoing and other features of the present invention are more readily apparent from the following detailed description and drawings of illustrative embodiments in which:

FIG. 1 shows a block diagram of the components of the system in an exemplary embodiment of the present invention;

FIG. 2 shows a block diagram of weighting matrixes used in the exemplary embodiment of the invention;

FIG. 3 shows a flow chart of the method selecting a suitable tutor and establishing a tutoring session in accordance with the exemplary embodiment;

FIG. 4 shows two exemplary weighting matrices in accordance with the exemplary embodiment;

FIG. 5 shows a block diagram of the selection of tutor based on tutor weighting matrices in accordance with the exemplary embodiment; and

FIG. 6 shows a sample Web page for student interface used in the exemplary embodiment of the present invention.

### DETAILED DESCRIPTION OF AN EMBODIMENT OF THE INVENTION

In an embodiment of the invention, students experiencing difficulty with a specific homework problem may seek the assistance of a personal tutor. Using a computer network, the student submits a request for academic assistance to a hosting server. The server determines the most suitable tutor from the tutors who are available. To make this determination, a weighting system is used in conjunction with automatic queuing, routing and communication services. Once a tutor is selected, a tutoring session is established directly between the tutor and student. The matching process takes place in real-time in response to the request for tutoring. The tutoring session provides a synchronized interactive learning environment.

While the embodiment is described with reference to a student and tutor in an academic learning environment, the present invention is not limited to such application. Student refers to any person seeking assistance and tutor or teacher refers to any person having skills and knowledge relating to the subject matter of the assistance sought. For example, the present invention may be applied to persons seeking advise or instruction regarding filing taxes, sewing a dress, growing string beans, playing the flute, or learning a second language.

The weighting system advantageously automates and optimizes the process of pairing online tutors/teachers with online students in order to deliver live, one-on-one tutoring and on-demand assistance. The use of weights provides a dynamic methodology for matching the standardized competency rankings of a pool of online tutors/teachers against the standardized, ranked requirements of online students in a constantly supply-and-demand environment.

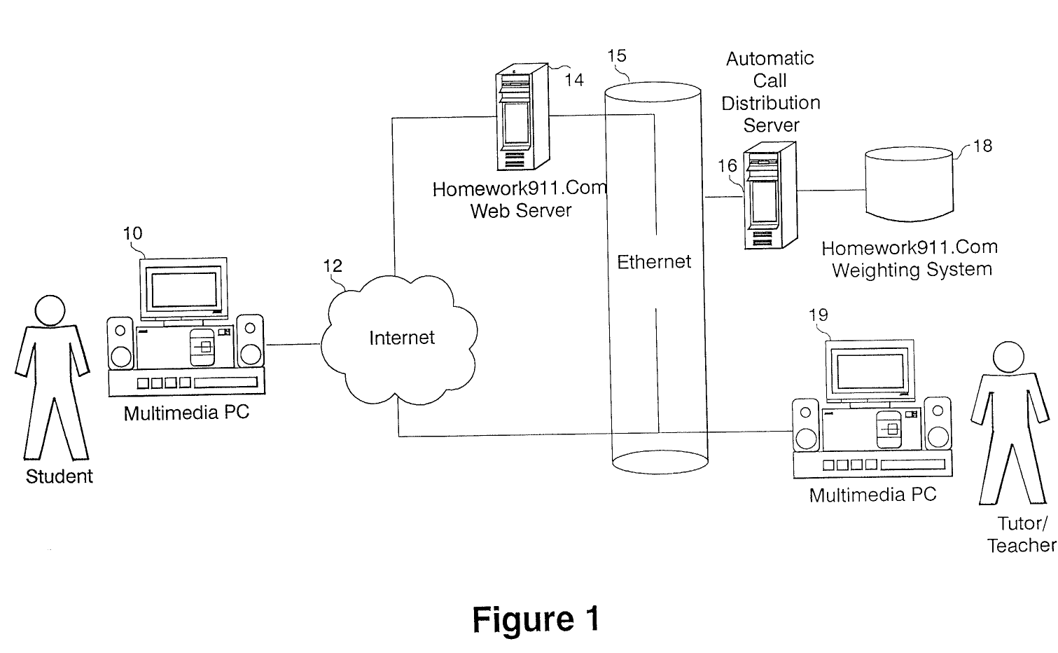

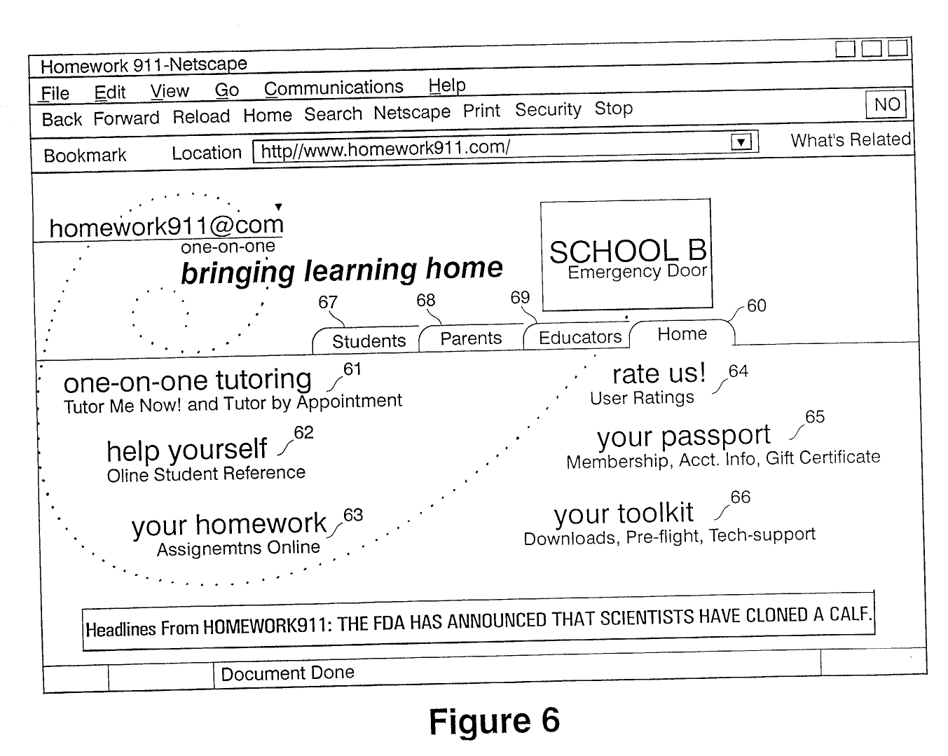

In an embodiment of the invention, a combination of Internet technology and communications queuing and routing systems, such as automated call distribution, provide the infrastructure to support the automated tutor selection process based on weighting system. Referring to FIG. 1, the student uses a multimedia personal computer 10 connected to the appropriate network, e.g., the Internet 12 to access the hosting server 14 at some remote location. The multimedia computer 10 may for example include speakers and a microphone. The hosting server provides the user-interface, such as a Web page(s), using some Internet facility such as the World Wide Web. See for example FIG. 6 which is described in more detail below. The host server 14 may be supplemented with a router server 16 such as a modified automatic call distributor 16 connected together via an Ethernet 15 or some other network device (local or remote) to facilitate and monitor communications among the students and tutors. A conventional automatic call distributor (ACD) is a computerized phone system that routes incoming telephone calls to operators or agents. Similar infrastructure and applications may be used to route the student's request with an available tutor. However if an ACD adapted to operate on the Internet is used, it may be modified to incorporate or cooperate with the weighting system.

The information about the tutors and students are organized and stored in a memory, e.g., a database 18. The tutors operate multimedia personal computers 19 located anywhere which are connected to the subject network, i.e., the Internet and optionally connected through the Ethernet. After the tutor and student are matched, they may communicate directly over the network without intervention of the Web server. The tutor's computer 19 connects to the student's computer via the Internet using TCP/IP, peer protocol, or some other network communications.

The selection/matching process is facilitated by a weighting system wherein the information about the tutors and students are organized in respective matrices. As used herein, a matrix is a data structure such as logic table. Each item or row in the matrix relates to a single selection criterion. Selection criteria consist of the substantive factors for determining the most suitable tutor by matching the student's needs with the tutors capabilities. As applied to the education model, the criteria incorporates, for example, the subject matter of the student's problem, the level of difficulty, the type of tutoring needed. The criteria relating to the tutors include, for example, the subject matters in which the tutor is sufficiently knowledgeable, the age and skill level of students, and the tutor's certifications. The criteria may be arranged with varying degree of specificity. For example, mathematics is a broad criterion; the student needs help with a math problem and the tutor indicates proficiency in math. More specific criteria relating to math include, elementary level arithmetic, third grade math, or fractions. Although there are many ways to define the students' needs and the tutor's capabilities, the only requirement to implement the automated selection process and weighting system, is that the definitions with respect to the student relate to the definitions with respect to the tutor. In other words, where the student's criteria is ninth grade math and the tutor's criteria is proficiency in algebra, the criteria are sufficiently cross referenced so as to result in a match. The request criteria of the student matrix must be capable of alignment with the competency criteria of the tutor matrices.

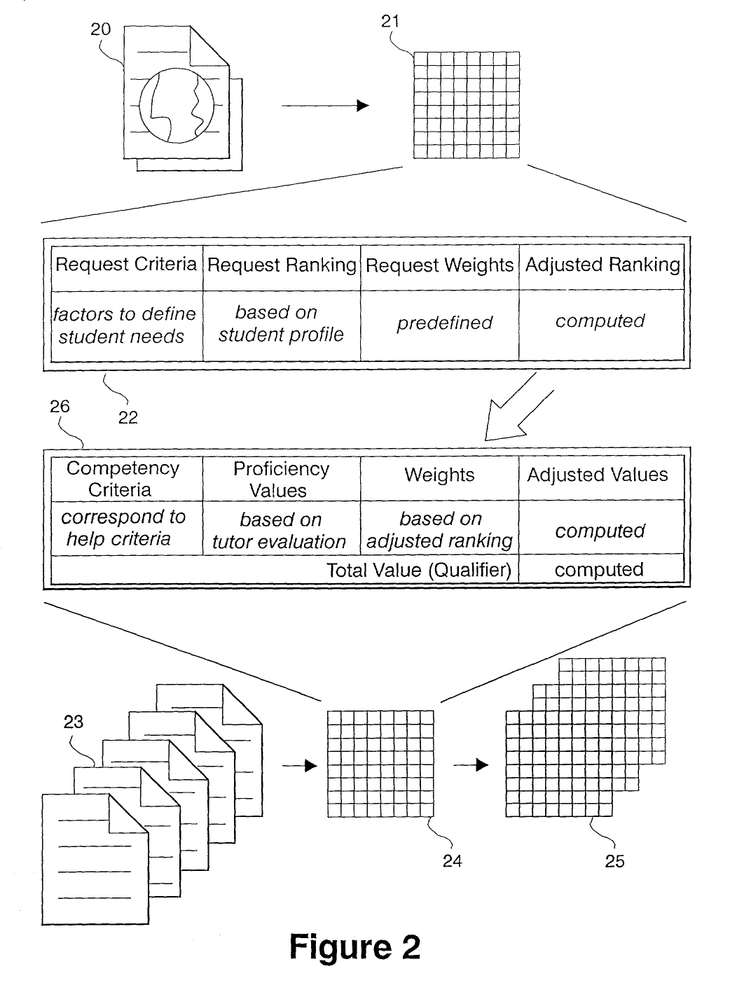

Referring to FIG. 2, the student provides information about him or herself and the help sought by way of the student profile feature 20 on the Web page hosted by the server. The student profile is an online questionnaire that captures essential background information about the student and the tutoring being sought, for example, her or his name, school level, special language requirements, and specifics about the type of homework help the student is now seeking. The student profile may receive very detailed information, such as, that the student needs help with a homework assignment calculating tangents. The student might also indicate the name of the textbook as well as identify the pages or problem numbers to be addressed in the tutoring session. The answer to each question in the student profile is a potential selection criterion. For information that will be used as the request criteria, the student is asked to quantify or rank them to distinguish between preferences and requirements.

The student profile is then compiled into a student weighting matrix 21 (also shown in more detail at 22). One column titled request criteria of the student matrix 22 contains factors that define the students needs. The request criteria corresponds to relevant fields of information comprising the student profile, meaning that each of fields of the student profile relate or translate to at least one help criterion. The next column indicates the request ranking which is based on the student profile. Sometime, two criteria in the matrix are needed to indicate certain information from the student profile. For example, with respect to the student's primary communication language, one criteria require that tutor be capable of communication in that language (yes or no) and another criteria to reflect the level of proficiency in that language (ranging 1 to 10).

Optimally the system also provides relative weights to offset skewing from the student's subjective ranking. Each of the request criteria is assigned a weight indicating its relative importance. For example the criterion relating to the student's primary language is more important than the tutor's gender or whether the tutor has access to the particular textbook. The relative weights may be determined based on education guidelines, expert opinions or surveys, some other reputable source. The student ranking are balanced by the relative weights to generate the adjusted ranking.

Similarly the tutor weighting matrix contains information about the tutor and his/her capabilities. The tutor certification and evaluation 23 relate to the competency criteria in the tutor weighting matrix 24 (also depicted in detail at 26). The evaluation may be determined based on various assessments, such as standardized tests, supervision evaluations, feedback from students, academic background, among others or combination of the foregoing. Proficiency values or quantifiers derived from an evaluation of the tutor or the tutor's certifications may be assigned to each competency criterion. The proficiency value for each competency criterion indicates the tutor's relative strength or weakness for the factor. The proficiency value may be numeric within a given range, reflecting for example, “excellent,” “good,” “average,” and “none,” depending on the tutor's strength in the respective capacity. Furthermore, the competency criteria correspond to the request criteria, such that the adjusted ranking may be used as weights to adjust the proficiency values of the tutor's competency. In this way the tutor's knowledge and skill are matched to the student's request for help. The proficiency values may be combined along with the corresponding weights (which are based on the adjusted ranking) to produce a qualifier or suitability measure for each tutor. Other factors such as availability may be provided by the routing services and taken into account in computing the qualifier values or in selecting a tutor based on the qualifiers. A matrix is generated for each participating tutor and the collection of tutor weighting matrices 25 may be stored in a database managed by one of the servers.

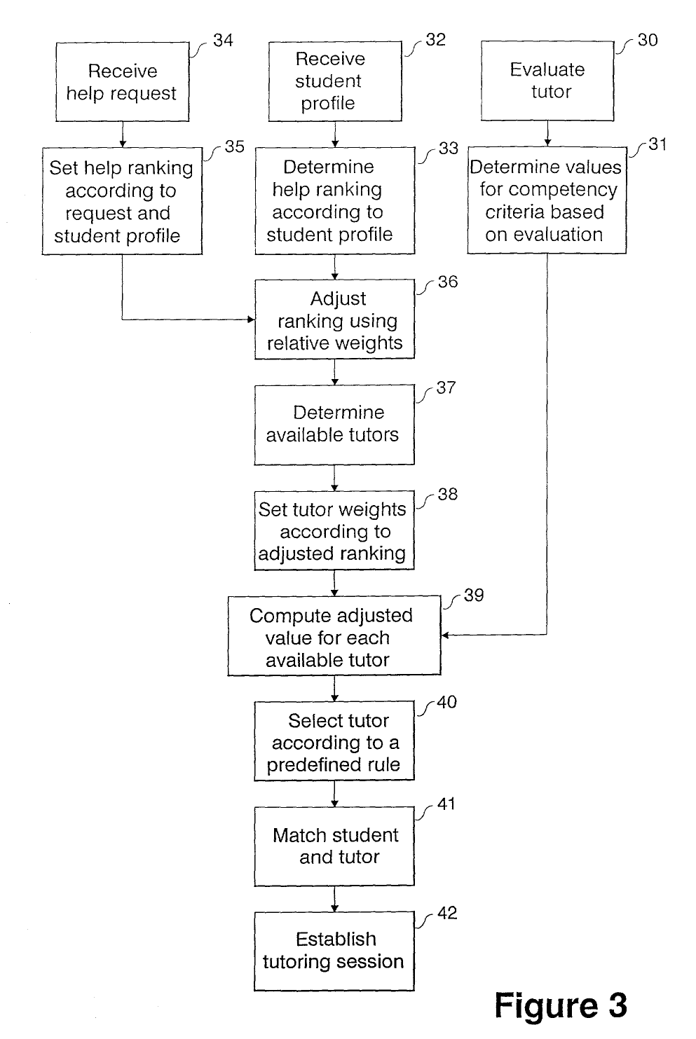

By way of overview of operations, the process is described with reference to FIG. 3. Each participating tutor is evaluated (step 30) for knowledge and skills. The evaluation may be conducted by the system as part of an initiation process. However, the evaluation may be conducted by an external third party at initiation or at some other time. Some care should be taken to ensure veracity of the tutor evaluations to maintain reputability. In addition, the tutor's certifications, degrees, education, background, and vital statistics may be incorporated in the matrix as well. At step 31, the various information about the tutor are synthesized to enable the automated selection/matching processes. For ease in data handling, most, if not all, the criteria are quantified as numeric values and included in the tutor weighting matrix.

At step 32, the server receives the student profile provided by the student, typically via the Web page interface. At step 33, the request ranking is determined according to the data of the student profile. The request ranking is included in the student weighting matrix. Optionally the student profiles may be maintained by one of the servers. If the profiles are retained, the server may accept help requests (step 34) involving less information than the student profile. A student returning to the system, having previously provided profile information, may provide information relating to the student's immediate needs. The server may then retrieve the student profile or student weighting matrix and update the request ranking accordingly (step 35). Once the ranking is determined, at step 36, the ranking is adjusted according to the relative weights previously defined. At step 37, the routing server or similar device is used to determine which of the participating tutors are currently available.

Availability may be defined as the presence of an active network connection that may be determined, for example, by automated detection such as polling, a registration scheme, or a schedule of tutoring sessions. For a tutor to be selected, the tutor must be have an active connection to the computer network and be ready to participate in a session. For example if a tutor is “logged on” to the Internet but temporarily indisposed, the tutor is not available. Tutors in this state may be solicited, e.g., via e-mail, instant messaging, chat, or paging, to assess when the tutor will become available. If the tutor is involved in another session, the router may estimate when the tutor will be available and incorporate the waiting time in the determination of availability. Determination of which participating tutors are online and currently unoccupied or, perhaps, soon to become available may be facilitated by the queuing and routing system. The pool of “available” tutors changes constantly in response to supply and demand.

For those tutors who are available, at step 38, the weights for the tutor weighting matrix is set according to the adjusted ranking in the student matrix for the student seeking help. Determining these weights may be performed prior to determining the availability of tutors without departure from the effectiveness of the process. At step 39, a qualifier is computed for each available tutor as follows: The proficiency value for each criterion is multiplied by the corresponding weight to produce an adjusted proficiency value. The adjusted proficiency values for all the criteria may be summed or averaged or otherwise combined to produce the total value or qualifier for each tutor. At step 40, the tutor with the best tutor is selected pursuant to a predetermined rule. A typical rule is that the highest value indicates the best tutor. However other factors aside from the matching criteria may be considered in selecting the best tutor. For example, the queuing and routing system may provide an estimated waiting time for those tutors who are temporarily indisposed rather than not available at all. The estimated waiting time affect the selection. For example, a tutor with a lower qualifier who is available immediately may be preferred and selected instead of a tutor with a higher qualifier value but a 10 minute estimated wait availability. At step 41, the tutor and student are matched and at step 42, a direct connection is established between the two thus facilitating the tutoring session. The server is not required to participate in the tutoring session.

The matching process is “multi-tiered” and “dynamic.” These qualities create an automated student-tutor matching process that, in conjunction with the automated queuing and routing, connects students to tutors based on a comprehensive, “best overall right now” approach that is quite unique.

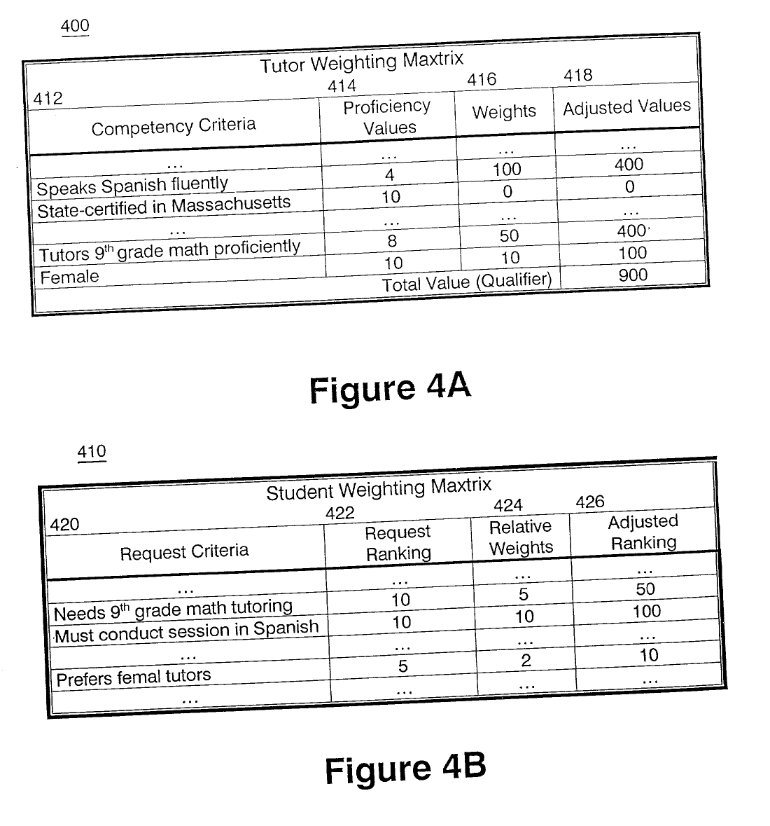

Both the Tutor Weighting Matrix 400 and the Student Weighting Matrix 410 contain multiple selection criteria, called competency criteria 412 and request criteria 420 respectively. For example, referring to FIG. 4, the Tutor Weighting Matrix might include such competency criteria 412 as “Speaks Spanish fluently,” “State-certified in Massachusetts,” “Tutors ninth grade mathematics proficiently,” “Is female,” and many other selection criteria. Each of these criteria are quantified to facilitate computation as indicated in the column titled proficiency values 414. In this example the values range from 1 to 10 with 10 indicating the most proficient. The proficiency values in this example indicate as follows: the tutor has some fluency in Spanish quantified as 4 and considerable proficiency in teaching ninth grade mathematics quantified as 8. In addition the tutor is female and certified in Massachusetts. (Boolean criteria may be indicated with 10 or 0 for yes or no, respectively.)

The Student Weighting Matrix 410 may include such request criteria 420 as “Needs 9^{th} grade math tutoring,” “Must conduct session in Spanish,” “Prefers female tutor,” and others. These criteria are ranked by the student in the student profile or accompanying a help request. The request ranking 422 in this example are 10, 10, and 5 respectively, indicating that the first two criteria are more important to the student than the third. Each criterion is associated with a relative weight as determined by some objective standard. In this example the relative weights 424 are 5, 19, and 2, respectively, indicating that the student's need for an expert in ninth grade math (in other words the tutor's proficiency in ninth grade math) is less important that the requirement that the tutor be able to converse in the student's language, Spanish. In addition, from an objective vantage, the tutor's gender is less important than the ninth grade math criteria, which is not to diminish the criteria but provide some perspective given the student's input. In this case, because Spanish fluency has a much higher criteria weight than ninth grade math proficiency, the weighting system might actually choose a tutor with a lower math tutoring proficiency but higher Spanish fluency. A great math tutor who cannot communicate with the student is of less value here than an acceptable math tutor who speaks Spanish well. This is reflected in the adjusted proficiency value. The request ranking 422 and the relative weights 424 are combined (e.g., multiplied) to generate an adjusted ranking 426.

The adjusted ranking 426 becomes the basis for the weights 416 used in the tutor matrix 400. In this example, the same values are used, but some formula or function may be applied to generate the weights from the adjusted ranking. The weights 416 are applied to the proficiency values 414, e.g., multiplied to produce adjusted values for the competency criteria. Finally the adjusted values may be combined, e.g., but summation or averaging, to produce a qualifier 428 susceptible to the automated selection process.

The weighting system can determine, using the Tutor Weighting Matrix, that a subset of the available tutors are qualified to tutor ninth grade math. And the system can seek the most proficient ninth grade math tutor by comparing each tutor's adjusted proficiency value for this selection criterion.

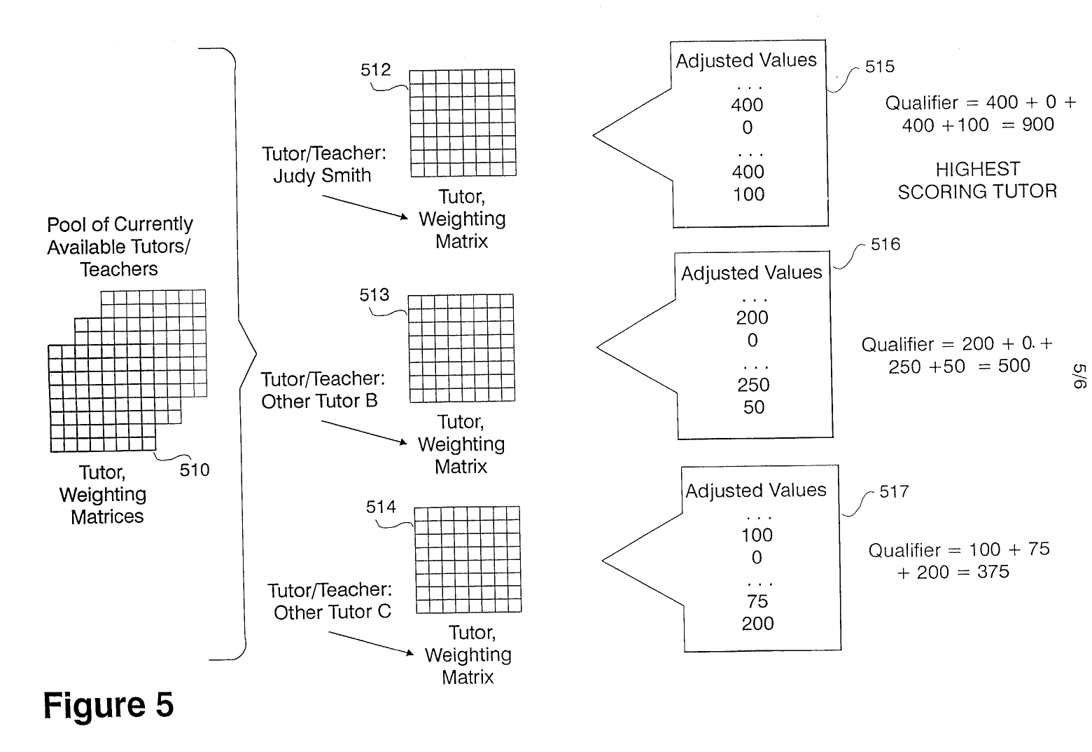

More generally, when using the highest value rule for best tutor, the weighting system compares the qualifiers for each tutor. Referring to FIG. 5, the system references the matrices for the pool of available tutors 510. Each matrix is considered individually. For example, matrices 512, 513, 514 are associated with Judy Smith, Tutor B and Tutor C, respectively. The adjusted values (515, 516, 517) for each tutor are summed producing qualifiers having the values 900, 500, and 375, respectively. Therefore selecting Judy Smith as the “best” tutor for the student requesting assistance with ninth grade math given the other considerations.

During the student-tutor matching process, the weights may be dynamically assigned or adjusted. The relative weights are generally determined based on some objective educational guideline. However, the guideline may incorporate some flexibility to be determined only when applied to the particular student matrix. Further, more the weights applied to the competency criteria are determined on-the-fly (in real time) in order to incorporate input from the student matrix.

Through the online student profile, the student can indicate and continually update many preferences and requirements that get recorded in his or her Student Weighting Matrix. At student-tutor session matching time, these indicators drive the assignment of weights to the various competency criteria within the Tutor Weighting Matrix. The routing system or similar service determines, at the same time, the potential tutors based on availability. All these factors combine and compete to generate a unique, composite, “best overall right now” assignment of tutor to student.

Other factors may be included in weighting system. For example, a parent may provide additional information about the student's learning needs. The additional information maybe substantive, for example, where the student is a young child who cannot clearly articulate the type of help needed. The information may be in the form of another ranking to adjust the ranking generated from the student information. In this context parent may include a guardian, regular teacher, guidance counsel, or someone helping the student.

Another type of factor that may be incorporated in the weighting system is certification information about the tutors. Such information may be a listing of the various state or board certifications for the tutor, and/or numerical scores for certain certifying exams.

An embodiment of the present invention is implemented by Homework911.com. Using a standard Web browser (e.g., Netscape Navigator or Microsoft Internet Explorer), the student accesses the Homework911.com Web site (e.g., www.homework911.com). The Homework911.com Web site is a publicly accessible site. Homework911.com may also offer private, co-branded versions of the site as well. The student coming to the site is greeted by the Homework911.com homepage, where a menu of services and collateral information is offered. Selection of one of the menu items takes the student to other Homework911.com Web pages. For access to fee-based services within the website, the student may be prompted for a Login ID and Password.

Referring to FIG. 6, the Homepage 60 shows some of the possible service offerings from Homework911.com. For example, the “Help Yourself—Online Student References” menu item 62 would take the student to a Web page for accessing a free online dictionary, thesaurus, encyclopedia and more. The “Your Homework” page 63 facilitates an application for guiding and assisting the student with assignments or problems generated by the tutor (within the system), teacher from the child's school or computer generated. A separate page “Students” 67 provides the questionnaire for receiving the student profile or help request. A “Parents” page 68 may provide information to parents about the tutoring program, their child's activities and progress, as well as, optionally receive ranking or other information to be incorporated by the weighting system. A “Educators” page 69 may provide professional tutors and teachers with information about the tutoring system and ways in which they may participate.

Other menu items include “One-On-One Tutoring” 61, “Your Passport” 65, and “Your Toolkit” 66. Each of these menu choices are linked to Web pages where the student may obtain items she or he will need in order to establish a live, one-on-one tutoring session. Other navigational pathways within the Site also lead the student to these same tutoring session prerequisites.

“Your Toolkit” 66 takes the student to Web pages where she or he may download free “toolkit” software to be used in the actual online tutorial sessions. After downloading and installing the Toolkit, the student can access the “Pre-Flight” Web page to test that the Toolkit has been properly set up and is ready for online tutorial sessions.

“Your Passport” 65 is an example menu choice leading into the E-Commerce area of the Homework911.com Web site. Here, the student, or her or his parent, may set up a Homework911.com Membership Account, including credit card information for subsequent billing purposes. The parent or student ma pre-purchase tutoring sessions here, or simply submit the credit card information for future authorization when an actual tutoring session occurs.

“One-On-One Tutoring” 61 is an example menu choice where the student accesses Web pages for obtaining an immediate tutoring session (“Tutor Me Now”) or to schedule an appointment for a future tutoring session (“Tutor by Appointment”). Information describing the services are also available on these Web pages. The student is prompted in the Web pages for their student profile. If the student requested Tutor by Appointment, scheduling information is obtained from the student.

If the student has created a student profile previously, the student can enter a Login ID and Password. Her or his student profile will then be retrieved and displayed. The Profile can be updated now if desired. If this is the student's first visit to the Site, upon creating and submitting the student profile, the student will be assigned a Login ID and Password.

Software resident at the Homework911.com Web Site examines the Login Id and Password submitted by the remote student. What happens next depends on whether this student's Membership Account already exists at Homework911.com and is authorized for new billing transactions. If the student does not yet have a Member Account, she or he will be automatically directed to the Homework911.com E-Commerce area described above under “Your Passport.” The student (or parent assisting the student) establishes a valid Membership Account before entering the queue for an actual tutoring session.

Once the student's Membership Account has been authorized, the Homework911.com system schedules the student for the tutoring session requested. The Homework911.com Weighting System (described above) operates in conjunction with the Homework911.com's routing software (which may be provided by a third party vendor) to determine the best tutor available to meet the student's needs.

For students using Tutor-Me-Now!, this automatic tutor selection may result in the immediate establishment of a one-on-one tutoring session between the live tutor and the student. If a delay is encountered, the student is forwarded to a “Please Wait” Web page, where the student may be informed that they are in line for a qualified tutor, and possibly, how long a delay is anticipated. When the appropriate tutor becomes available, the Homework911.com system automatically alerts the student and establishes the live tutoring session.

For Tutor-By-Appointment student the Homework911.com system advises that student that the appointment is confirmed, provides date and time information and any additional instructions the student might need. The system may also send and email encapsulating this information to the student's email address.

The Homework911.com routing and weighting system matches the student to a qualified tutor automatically, and at the appropriate moment, establishes a direct, peer-to-peer Internet connection between the two. Where the student has to wait for an available tutor, the system may employ a call back feature. The student is alerted when the tutor is online and ready to commence tutoring by sending a notice via for example, instant messaging, relay chat, e-mail, pager, or phone. The call back feature may also be used to alert a tutor that an assigned student is ready and awaiting to commence the tutoring session.

The tutoring session need not be Web-based. Communication between tutor and student may use such IP (Internet Protocol) telephony technologies as voice-over-IP, video-uses such IP (Internet Protocol) telephony technologies as voice-over-IP, video-over-IP, IP-based-whiteboard, Internet text chat, application-sharing and others.

Furthermore, using these tools, the tutor is able to remotely control the characteristics of the toolkit that appears at the student's PC. For example, the tutor can decide at a certain point that sharing a whiteboard with the student would be useful. Using software controls at the tutor's computer, the tutor can cause a shared whiteboard to appear simultaneously on the computer screens of the tutor and of the student.

When the tutor-student session is being established, the Homework911.com system appraises the tutor of the student's requirements for this session. For example, the tutor may be informed that the student speaks only Spanish and the session must therefore be conducted in Spanish. The system also informs the tutor of the specific homework problem for which the student is seeking is using, the tutor may access a digitized copy of the textbook if Homework911.com has the book in its online repository.

With the above information, the tutor can now begin working with the student. Typically, the first thing the student will see on her or his computer is a video window, showing the live video image of the tutor and captioned with the tutor's first name. For privacy reasons, the student's image is not transmitted back to the tutor. The tutor may then choose to welcome the student audibly (voice-over-IP) or, perhaps, textually, using the text-chat tool. Where bandwidth between tutor and student is limited, video quality is sacrificed in favor of audio quality.

Two popular teaching tools are the shared whiteboard and the live, two-way audio capability. The tutor and student can write and draw on the shared whiteboard, for example, to illustrate the process for calculating a tangent. Question and answer occur via the audio. Sometimes words may be indistinct via audio or spelling may be a question. In this case, the tutor may choose to use the text-chat tool to display typewritten words to the student.

Other tools available to the tutor include application-sharing and the following-me-browsing. Application sharing enables the tutor to display on the student's computer screen a particular application program that the tutor is running. Follow-me-browsing enables the tutor to synchronize the tutor's Web browser with the student's Web browser so that the tutor can lead the student to Web pages on the Internet.

When the tutor and student agree that the tutoring session is at an end, one or the other can terminate the session using the Log Off tool. The Homework911.com system may record final information regarding the session, for example, its total time duration. The tutor may then be asked by the Homework911.com system to type in information regarding the session that can be included in an email sent automatically to the student's parents email address, if it is on file.

While the invention has been particularly shown and described with reference to preferred embodiments thereof, it will be understood by those skilled in the art that various changes in form and details may be made therein without departing from the spirit of the invention.

We claim:

1. A method for automatically selecting a qualified tutor to assist a student, the method comprising the steps of:
receiving the request for tutoring from said student;
ranking a predetermined set of criteria according to said request for tutoring;
determining proficiency measurements for said set of criteria for each of a plurality of tutors;
computing a qualifier for each of said plurality of tutors as a function of said ranking and said proficiency measurements; and
selecting said qualified tutor according to a predetermined rule applied to said qualifiers.

2. The method of claim 1, wherein said predetermined rule operates to select the tutor having the highest value qualifier.

3. The method of claim 1, further comprising the step of establishing a synchronous tutoring session between the student and matching tutor.

4. The method of claim 3, further comprising the step of charging a fee for the tutoring session.

5. The method of claim 1, further comprising the step establishing a tutoring session contemporaneously with and in response to said receiving step.

6. The method of claim 1, further comprising the steps of determining availability for said plurality of tutors; and
selecting said qualified tutor according to said availability and said qualifiers.

7. A method for establishing a personal tutoring session for a student using a computer network comprising the steps of:
evaluating a plurality of tutors according to a predetermined competency criteria;
assigning a proficiency value for each of said competency criteria for each of said tutors based on said evaluation;
receiving from the student through the computer network a ranking for a request criteria, said request criteria corresponding to said competency criteria;
determining available tutors among said plurality of tutors;
computing a total value for each of said available tutors as a function of said ranking and said proficiency values in accordance with said correspondence between said request criteria and said competency criteria;
selecting a preferred tutor based on said total values computed for each of said available tutors; and
establishing a tutoring session between said student and said preferred tutor using the computer network.

8. The method of claim 7, further comprising the steps of determining a highest value of the total values computed and selecting the tutor with said highest value.

9. The method of claim 7, wherein a plurality of relative weights are associated with said request criteria, further comprising the step of adjusting said ranking based on said relative weights according to the corresponding request criteria.

10. The method of claim 7, further comprising the step of establishing said tutoring session contemporaneously with the step of receiving said ranking from said student.

11. The method of claim 7, further comprising the steps of determining a wait time for each of said available tutors, wherein said wait time may be none; and
selecting said preferred tutor according to a function of said total values and said wait time for said available tutors.

12. The method of claim 7, further comprising the steps of determining a parent ranking corresponding to said request criteria; modifying said ranking received from said student according to said parent ranking; and using a resulting modified ranking to compute said criteria weights.

13. The method of claim 7, further comprising the steps of determining certification values for at least one of said competency criteria; modifying said proficiency values for said competency criteria according to said certification values; and using resulting modified proficiency values for computing said total values for each of said available tutors.

14. A system for facilitating tutoring for students who request assistance, said system comprising:
a hosting server for interfacing with said students to receive requests, said server having a processor for selecting a preferred tutor from available tutors according to a ranking of a criteria and proficiency values corresponding to said criteria;
a routing server for determining the availability of tutors and for routing student requests;
a memory for storing said criteria, said ranking and said proficiency values; and
a connection to a computer network accessible to said students and said tutors.

15. A system for automatically selecting a qualified tutor to assist a student, comprising:
a processor; and
a memory in operative connection with the processor for storing processing instructions enabling the processor to:
receive the request for tutoring from said student;
rank a predetermined set of criteria according to said request for tutoring;
determine a set of proficiency measurements for said set of criteria for each of a plurality of tutors;
compute a qualifier for each of said plurality of tutors as a function of said ranking and said proficiency measurements; and
select the tutor according to a predetermined rule applied to said qualifiers.
